(19) United States
(12) Patent Application Publication
(10) Pub. No.: US 2002/0155240 A1
(43) Pub. Date: Oct. 24, 2002

(54) Firestopping sleeve

(76) Inventor: Arndt Andresen, Tulsa, OK (US)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/120,718

(22) Filed: Apr. 11, 2002

(30) Foreign Application Priority Data
Apr. 19, 2001 (DE) 10119132.4

(51) Int. Cl. B32B 1/08

(52) U.S. Cl. 428/36.9; 428/99

(57) ABSTRACT

A firestopping sleeve (1, 1′) for a conduit (4) extending through an opening (2) in a wall (3) has the conduit surrounded by a torus shaped fire-proof fabric tube (5) filled with intumescent material (13) which expands in the event of fire and sealingly closes off the opening (2). The fabric tube (5), has at least one tube section (6a, 6b) lying within the torus and closed with respect to the rest of the fabric tube (5).

### FIELD OF THE INVENTION

The invention relates to a firestopping sleeve for pipes, cables and the like.

### BACKGROUND OF THE INVENTION

Firestopping sleeves serve as fire protection components in passages through masonry in walls, ceilings, floors of buildings. In such structures they are intended to close off the passages in the case of flammable or melting piping, cables and the like made of plastic, glass, aluminum, and the like in order to prevent the spread of the fire; such piping being hereinafter collectively called conduits.

The well-known firestopping sleeves conventionally have a tubular metal casing with a closure mechanism. Conventionally, a sufficient quantity of intumescent material is installed in the casing and as a rule is embedded in a binding matrix. In the event of fire, such material expands and closes off the opening that results from the burning away or melting of the conduit.

According to DE 3930722A1 a firestopping sleeve contains within a rigid casing an intumescent material, which is present in a loose, granular form in combustible, partially filled bags that are divided into chambers. Each part of an additional curtain that closes off the annular space as a blocking component is fashioned from a folded fabric flexible tube comprised of woven glass fabric. The curtain is not rigid and requires a large toroidal expansion volume for radial closure of the front of the firestopping sleeve, whereby the firestopping sleeve must have a relatively large sheath thickness in order to receive the intumescent material.

According to EP 988873 a firestopping sleeve is disclosed that has a toroidal fabric tube for receiving intumescent material, which is installed in the form of an annular strip into the fabric tube. The heavily congested folds formed in the quasi-central zone on the inner sheath surface at the time of expansion of the fabric tube of this type limit the tightness of the smoke seal of the firestopping sleeve.

### SUMMARY OF THE INVENTION

The object of the present invention is to provide a firestopping sleeve formed of a fabric tube with improved tightness of the smoke seal.

Generally a firestopping sleeve for a conduit extending through an opening in a wall circumferentially encloses the conduit in an axially extending zone in a torus shaped fire resistant fabric tube containing an intumescent material, which in the event of fire expands and together with the fabric tube sealingly closes off the opening, whereby a tubular section is arranged within the torus, closed with respect to the rest of the fabric tube and is arranged in order to fill out the central zone.

In the event of fire, the expanded tube section, which is closed relative to the rest of the torus shaped fabric tube, fills the central zone within the torus without the occurrence of folds, since it is arranged as a compact body inside the toroidally expanded remainder of the fabric tube. The remaining, minimally congested folds in the radial circumferential zone from the edge zone to the central zone as well as at the external shell only minimally impair the smoke-tight seal.

Advantageously, the two part temperature resistant closed torus shaped fabric tube on the circumference of the conduit has, at an end of the tube section, a temperature resistant, transverse seam along the conduit, further advantageously parallel to the conduit as a bending edge for the tube section, whereby in the event of fire a defined distribution of expanding material or filling volume between the tube section and the rest of the fabric tube is produced and a defined orientation of the tube section is achieved.

Preferably, the length of the tube section is in the range between one half and the entire diameter of the conduit, and further it is approximately 0.85 times the diameter, whereby an optimum filling of the central zone within the torus shaped fabric tube is achieved.

Advantageously, the intumescent material is enclosed in an easily destroyable foil tube and the foil tube is arranged longitudinally inside the fire resistant fabric tube, whereby loose intumescent material is locally fixed and is circumferentially evenly distributed.

Advantageously, the circumferentially larger fabric tube, with inwardly and symmetrically axially protruding edge zones, is folded radially around the foil tube, whereby the fabric tube can in the event of fire unfold radially inwardly resulting in an axially uniform distribution of the intumescent material.

Advantageously, the torus shaped fabric tube has two closed, separate, opposed tube sections lying within the fabric tube, which flatly abut one another and fill up the central zone without folds, whereby such zone is radially larger and consequently the wall thickness of the torus shaped residual fabric tube can have smaller dimensions, and the remaining folds in the radial transitional zone are even less congested and consequently the smoke tight seal is enhanced.

Preferably, two partial fabric tubes form the torus shaped tube, each connected with the other and to one tube section over at least one common temperature resistant seam or connector to the torus shaped fabric tube with two tube sections, advantageously diametrically opposed, whereby their manufacture is simplified.

Advantageously, the firestopping sleeve consists exclusively of the fabric tube filled with intumescent material and fitting means for the necessary fitting of the firestopping sleeve adjacent to the opening, whereby the firestopping sleeve can be generally flexibly formed.

Alternatively, the firestopping sleeve consists of the fabric tube filled with intumescent material within a rigid annular cuff with fitting means for the necessary attachment of the firestopping sleeve adjacent to the opening, whereby the firestopping sleeve can resist higher mechanical loads.

Also advantageously, the firestopping sleeve can be circumferentially hinged and joined encirclingly around the conduit using a binding means, whereby the firestopping sleeve can be mounted transverse to the conduit.

### BRIEF DESCRIPTION OF THE DRAWING

The invention is more completely described with reference to exemplary embodiments read together with:

FIG. 1 illustrates a firestopping sleeve in the unexpanded condition;

FIG. 2 shows a variant of the firestopping sleeve in the expanded condition; and

FIG. 3 represents a fabric tube in circumferential section.

### DETAILED DESCRIPTION OF THE INVENTION

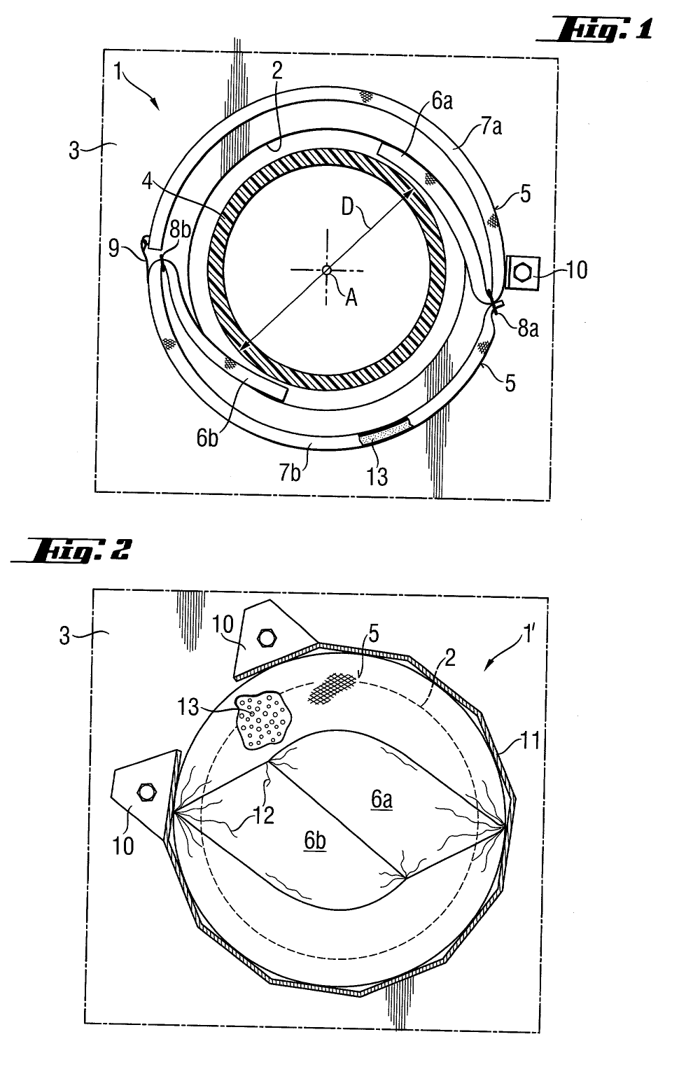

According to FIG. 1, a firestopping sleeve 1 for a conduit 4 extending through an opening 2 in a wall 3 has a torus shaped, folded fabric tube 5 circumferentially encircling the conduit in an axially extending zone relative to axis A. The fabric tube 5 is formed of a fire-proof material such as woven glass of aramid fibers, containing intumescent material, wherein two folded tube sections 6a, 6b are connected to the torus shaped fabric tube 5 and lying inside the torus with respect to the rest of the fabric tube 5, the tube sections being separate and diametrically opposed to each other. The torus shaped fabric tube 5 itself consists of two partial fabric tubes 7a, 7b situated diametrically opposite to each other, which are fixed by means of a temperature resistant transverse seam or connector 8a and detachable using a latch means 9 in the form of a hook and eyelet, and each connected to a tube section 6a, 6b. The firestopping sleeve 1 is mounted using a mounting means 10 in the form of a metal bracket on the wall 3 around the opening 2. Appropriate dimensioning of the fabric tube for a conduit diameter D is a fabric tube diameter of approximately 0.3×D and a total tube length of approximately 2.6×D, wherein the partial length of the tube sections 6a, 6b separated by the transverse seam 8a, 8b is approximately 0.85×D.

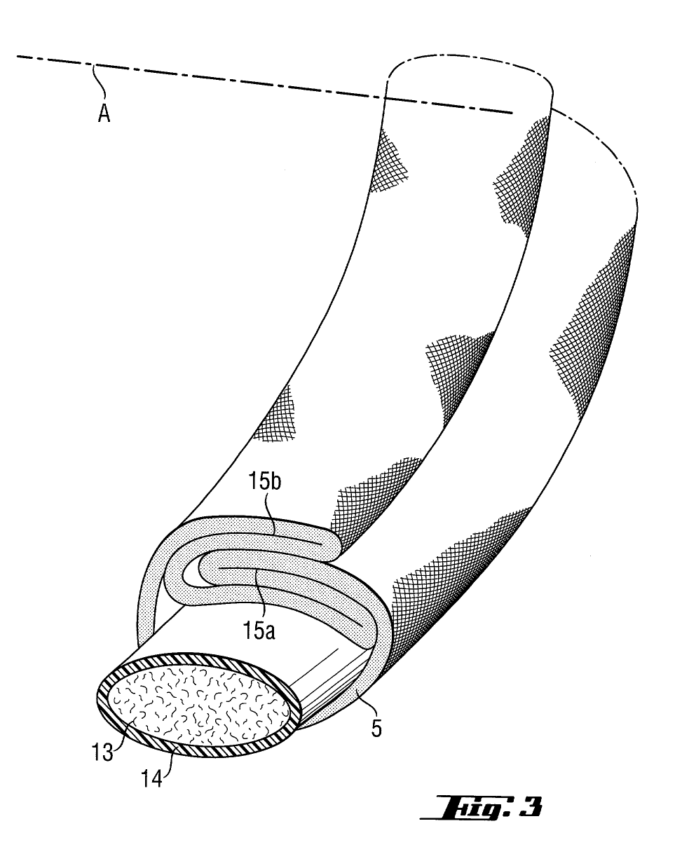

In FIG. 2, a variant of the firestopping sleeve 1 is shown with an external, annular curved, circumferentially open, rigid annular collar 11 and two mounting means 10 arranged terminally at both ends of the collar and a fabric tube 5 within, which, in the event of fire, is explosively filled out by the expanding intumescent material contained therein and the opening 2 in the wall 3 is sealed smoke-tight. The two tube sections 6a, 6b, closed relative to the rest of the fabric tube 5, lying flatly and without folds upon each other fill the central zone within the torus, whereby only minimum congested folds 12 form only in the radial transitional area from the edge zone to the central zone and at the outer surface of the torus.

According to FIG. 3, in the section circumferential to the axis A, the loose intumescent material 13 is situated in an easily destroyable foil tube 14 and the tube is arranged lengthwise inside the fire-proof fabric tube 5. The circumferentially larger fabric tube 5 is folded symmetrical to both axially protruding edge zones 15a, 15b radially around the foil tube 14 inwardly towards the axis A.

What is claimed is:

1. A firestopping sleeve for a conduit (4) extending through an opening (2) in a wall (3) comprises a torus shaped fire-proof fabric tube (5) for encircling the conduit (4) and containing an intumescent material (13) arranged to expand when exposed to a fire so that the expanded fabric tube (5) closes off and seals the opening (2), said fabric tube (5) comprises at least one tube section (6a, 6b) forming a part of and closed off from and located radially inwardly of said torus shaped fabric tube (5), and radially outwardly of the conduit (4).

2. A firestopping sleeve, as set forth in claim 1, wherein two said tube sections (6a, 6b) are part of said torus shaped fabric tube (5) and are temperature resistantly secured in a closed manner thereto.

3. A firestopping sleeve, as set forth in claim 1, wherein said tube section (6a, 6b) has a length in the range of one-half to the full diameter (D) of said conduit (4).

4. A firestopping sleeve, as set forth in claim 1, wherein said tube section (6a, 6b) has a length of approximately 0.85 times the diameter of the conduit (4).

5. A firestopping sleeve, as set forth in claim 1, wherein said intumescent material (13) is enclosed within an easily destroyable foil tube (14) arranged lengthwise within said fire-proof fabric tube (5).

6. A firestopping sleeve, as set forth in claim 5, wherein said fire-proof fabric tube (5) is larger in the circumferential direction than said foil tube (14) and is folded radially inwardly about and in contact with said foil tube (14).

7. A firestopping sleeve, as set forth in claim 6, wherein said fabric tube is folded inwardly in a symmetrical manner about said foil tube (14).

8. A firestopping sleeve, as set forth in claim 2, wherein said closed tube sections (6a, 6b) are arranged separately diametrically opposite one another.

9. A firestopping sleeve, as set forth in claim 2, wherein said fire-proof fabric tube (5) forming the torus shape comprises two partial fabric tubes (7a, 7b) each with a separate said tube section (6a, 6b) connected thereto and said fabric tubes (7a, 7b) are connected together by at least one temperature resistant connector.

10. A firestopping sleeve, as set forth in claim 9, wherein said partial fabric tubes (7a, 7b) are located diametrically opposite one another.

11. A firestopping sleeve, as set forth in claim 1, consists of said fire-proof fabric tube (5) containing said intumescent material (13) and mounting means (18) for securing said fabric tube (5) to the wall (3).

12. A firestopping sleeve, as set forth in claim 1, consists of said fabric tube containing said intumescent material (13) within a rigid partially annular cuff (11) including mounting means (10) for securing said fabric tube (5) to the wall (3).

13. A firestopping sleeve, as set forth in claim 1, wherein said torus shaped fabric tube (5) is discontinuous in the circumferential direction with adjacent ends thereof secured together by a fastening member (9).
